(19) United States
(12) Patent Application Publication
(10) Pub. No.: US 2013/0277526 A1
(43) Pub. Date: Oct. 24, 2013

(54) HOLDER FOR A PET TOY

(71) Applicant: Allan Wendling, (US)

(72) Inventor: Allan Wendling, (US)

(21) Appl. No.: 13/454,374

(22) Filed: Apr. 24, 2012

(51) Int. Cl. A01K 29/00; A47G 29/00

(52) U.S. Cl. 248/346.03

(57) ABSTRACT

A holder for a pet toy having a base and a support secured to and extending upwardly from a top of the base. The support also includes an upper support surface with a groove dimensioned to receive a pet toy. An elastic strap is secured to the base and extends over the support surface to releasably attach a pet toy positioned in between the strap and the support surface of the support.

### BACKGROUND OF THE INVENTION

I. Field of the Invention

The present invention relates to a holder for a pet toy.

II. Description of Related Art

Many people own pets that are kept inside the house. Some pets, and in particular dogs, instinctively chew objects found within the household. In order to accommodate this instinctive chewing by the pet dog, and also to protect other items within the household, many pet owners provide the dog with a chew bone or other chew toy.

One problem with chew toys for pets, and particularly pet dogs, is that the dog will drag the chew toy around the house, oftentimes losing it. Similarly, the pet may leave the chew toy in places around the home where the chew toy is unwanted.

### SUMMARY OF THE PRESENT INVENTION

The present invention provides a holder for a pet toy which overcomes the above mentioned disadvantages of the prior art.

In brief, the present invention provides a holder for a pet toy having a base with a top. A support is secured to and extends upwardly from the top of the base and that support in turn has an upper support surface. This upper support surface preferably includes a central notch designed to receive a portion of a pet chew toy.

With a pet chew toy positioned within the notch, an elastic strap is fixedly secured at one end to the support, extends over the upper support surface, and is releasably secured to the support at its other end. In doing so, the strap releasably attaches the pet toy positioned in between the strap and the support surface to the support. The releasable attachment of the strap to the support is preferably adjustable in length in order to accommodate different sizes of pet toys positioned on the support.

In practice, with the pet toy positioned on the upper surface of the support and secured in place with the elastic strap, the pet is able to chew the pet toy but unable to remove the chew toy from the support. Furthermore, the base is dimensioned so that, when the pet is chewing on the chew toy, at least a portion of the weight of the pet is exerted on the top surface of the base thus effectively holding the base with its attached chew toy in a stationary position. In this fashion, the pet is unable to either remove the pet toy from the support or to move the entire holder for the pet toy.

### BRIEF DESCRIPTION OF THE DRAWING

A better understanding of the present invention will be had upon reference to the following detailed description when read in conjunction with the accompanying drawing, wherein like reference characters refer to like parts throughout the several views, and in which:

FIG. 1 is a perspective view illustrating a preferred embodiment of the present invention;

FIG. 2 is a side view illustrating the preferred embodiment of the invention;

FIG. 3 is a rear view of the preferred embodiment of the invention; and

FIG. 4 is an exploded view of the pet toy holder.

### DETAILED DESCRIPTION OF A PREFERRED EMBODIMENT OF THE PRESENT INVENTION

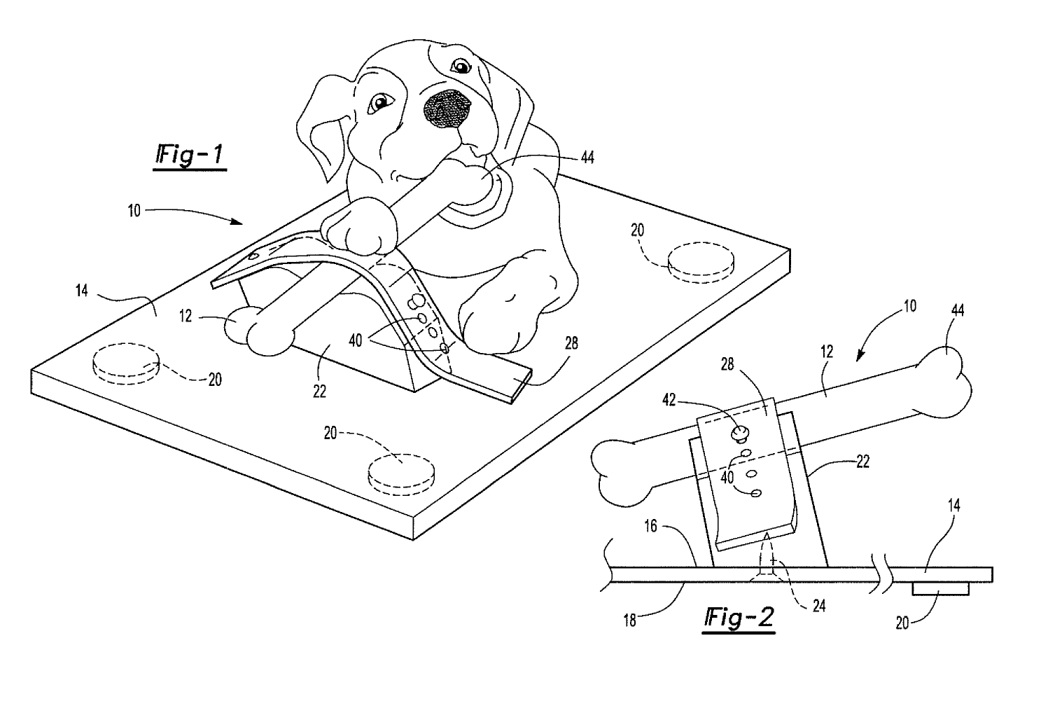

With reference first to FIGS. 1 and 2, a preferred embodiment of a holder 10 for a pet toy 12 is shown. The holder 10 includes a generally planar base 14 having both an upper surface 16 and a lower surface 18. The base 14 is adapted to be positioned on a floor with its lower surface 18 facing the floor and its upper surface 16 facing upwardly away from the floor. Anti-scratch cushions 20 (only one shown) are preferably attached to the bottom surface 18 of the base 14 to protect the floor surface.

A support 22 is secured to the base 14 in any conventional fashion, such as by screws 24. The support 22 is preferably positioned near the center of the base 14 for a reason to be subsequently described.

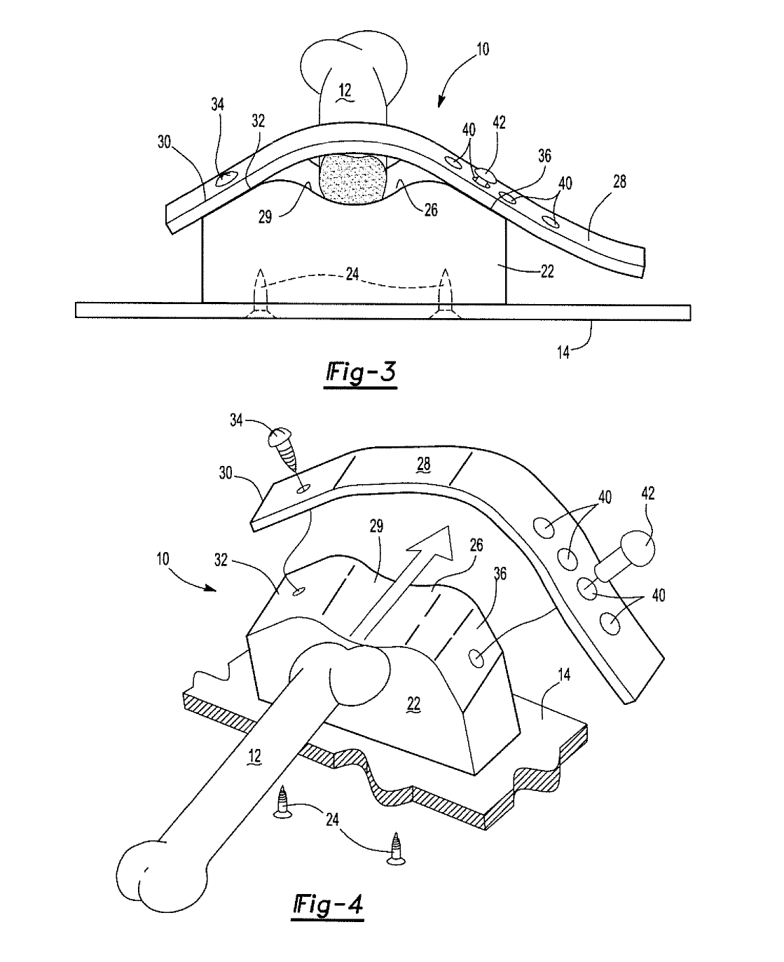

Referring to FIGS. 3 and 4, the support 22 includes an upper support surface 26 preferably having a central notch 28. This notch 28, furthermore, is dimensioned so that at least a portion of the pet toy 12 can be positioned within the notch 28.

As best shown in FIG. 2, the support 22 is generally planar with its plane intersecting the plane of the base 14 at an acute angle. The upper support surface 26 of the support 22 also includes at least a portion that is planar and which intersects the plane of the base 14 at an acute angle.

With reference now to FIGS. 3 and 4, an elongated elastic strap 28 has one end 30 secured to one side 32 of the support 22 by any conventional fashion, such as a fastener 34. The end 30 of the elastic strap 28 may be either fixedly secured to the support 22, or removably secured to the support 22, but is preferably fixedly secured.

With the pet toy 12 positioned within the notch 28, the strap 28 extends over the pet toy 12 so that the pet toy 12 is entrapped in between the strap 28 and the support surface 26 of the support 22. The other end 34 is then releasably attached to the side 36 opposite the side 32 of the support so that the elastic strap 28 is in a state of tension. Any conventional means may be used to detachably attach the end 34 of the strap 28 to the support 22, but in the preferred embodiment of the invention, the strap 28 includes a plurality of longitudinally spaced openings 40 while a pin 42 with an enlarged head is attached to the side 36 of the support 22. The tension on the strap 28 may be adjusted by selecting different holes 40 and the strap 28 is positioned so that the pin 42 extends through one of the holes 40 thus releasably securing the end of the strap 28 to the support 22.

As shown in FIGS. 1 and 2, with the pet toy 12 attached to the support 22 as described, one end 44 of the pet toy 12 is angled upwardly due to the angled upper support surface 29 to hold the pet toy 12 in a desirable position and provide easy access for the pet. Furthermore, when the pet is chewing on the pet toy 12, one or more paws of the pet is positioned on top of the base 14 thus holding the base 14 in place.

In practice, the elastic strap 28 effectively retains the pet toy 12 to the support 22 so that the pet toy 12 cannot be removed and lost. However, the elastic strap 28 does allow some movement of the pet toy 12 so that the dog can position the pet toy as desired. When desired, a new pet toy may be easily replaced by simply releasing the end 34 of the elastic strap and placing a new pet toy on the support surface 26 of the support 22 and then reattaching the elastic strap 28 to the support 22.

From the foregoing, it can be seen that the present invention provides a simple yet effective holder for a pet toy. Having described my invention, however, many modifications thereto will become apparent to those skilled in the art to which it pertains without deviation from the spirit of the invention as defined by the scope of the appended claims.

I claim:

1. A holder for a pet toy comprising:
a base having a top,
a support secured to and extending upwardly from said top of said base, said support having an upper support surface,
an elastic strap secured to said support and extending over said support surface to thereby releasably attach the pet toy positioned between said strap and said support surface.

2. The holder for a pet toy as defined in claim 1 wherein said strap is elongated and has one end fixedly attached to said support and a second end releasably attached to said support.

3. The holder for a pet toy as defined in claim 2 and comprising a pin attached to and protruding outwardly from said support, said strap having a plurality of longitudinally spaced holes adjacent its second end and wherein said second end of said strap is releasably attached to said support by positioning said pin through one of said holes in said strap.

4. The holder for a pet toy as defined in claim 1 wherein at least a portion of said support surface lies in a plane oblique to a plane of said base.

5. The holder for a pet toy as defined in claim 1 wherein at least a portion of said support surface lies in a non-horizontal plane when a plane of said base is positioned in a horizontal plane.

6. The holder for a pet toy as defined in claim 1 wherein said support surface includes a notch dimensioned to receive a portion of the pet toy.

7. The holder for a pet toy as defined in claim 1 where said base is planar.
